(19) United States
(12) Patent Application Publication
(10) Pub. No.: US 2013/0290405 A1
(43) Pub. Date: Oct. 31, 2013

(54) TEST SYSTEM AND TEST METHOD USING SAME FOR AUTOMATICALLY DISTRIBUTING TEST FILES

(71) Applicants: SHIH-FANG WONG, Tu-Cheng (TW); XIN LU, Shenzhen City (CN); FEI WANG, Shenzhen City (CN); HUI-FENG LIU, Shenzhen City (CN); BIAO-GENG ZHONG, Shenzhen City (CN); YAO-HUA LIU, Shenzhen City (CN); YU-CUI ZHOU, Shenzhen City (CN); JUN-JIE LI, Shenzhen City (CN)

(72) Inventors: SHIH-FANG WONG, Tu-Cheng (TW); XIN LU, Shenzhen City (CN); FEI WANG, Shenzhen City (CN); HUI-FENG LIU, Shenzhen City (CN); BIAO-GENG ZHONG, Shenzhen City (CN); YAO-HUA LIU, Shenzhen City (CN); YU-CUI ZHOU, Shenzhen City (CN); JUN-JIE LI, Shenzhen City (CN)

(21) Appl. No.: 13/664,431

(22) Filed: Oct. 31, 2012

(30) Foreign Application Priority Data
Apr. 25, 2012 (CN) 201210123619.2

(51) Int. Cl. G06F 15/16

(52) U.S. Cl. 709/203

(57) ABSTRACT

A test system includes a master server and a plurality of client servers, the master server includes a test file management module. The test file management module sets authorizations for different users, receives and transforms first test files from a special format into a common format, generates a plurality of second test files to define a plurality of tests using the common format first test files, distributes the second test files to the client servers, controls a process of each test to obtain test result, and records and analyzes test result of each test. The present disclosure also provides a test method using the test system.

### TECHNICAL FIELD

Embodiments of the present disclosure relate to a test system and a test method using the same for automatically distributing test files.

### DESCRIPTION OF RELATED ART

Electronic apparatus such as liquid crystal displays (LCDs) are popular and widely used. Normally, an electronic apparatus needs to be manufactured and tested according to design specification. Furthermore, some customers may desire that the manufacturer performs specific test according to a test file. As such, the customer may give the factory an undetachable test file and appoint the factory to perform several special tests according to the undetachable test file. Under this condition, it is difficult for the factory to reasonably distribute tests to their different test devices using the undetachable test file. Therefore an efficiency to achieve the special tests will be very low.

Thus, a new test system and a test method are desired to overcome the above-described shortcomings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram illustrating one embodiment of a test system including a test file management module.

FIG. 2 is a schematic block diagram illustrating one embodiment of functional modules of the test file management module of FIG. 1.

FIG. 3 is a flowchart of one embodiment showing a test method of the test system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include compact discs (CDs), digital video discs (DVDs), BLU-RAY disks, Flash memory, and hard disk drives.

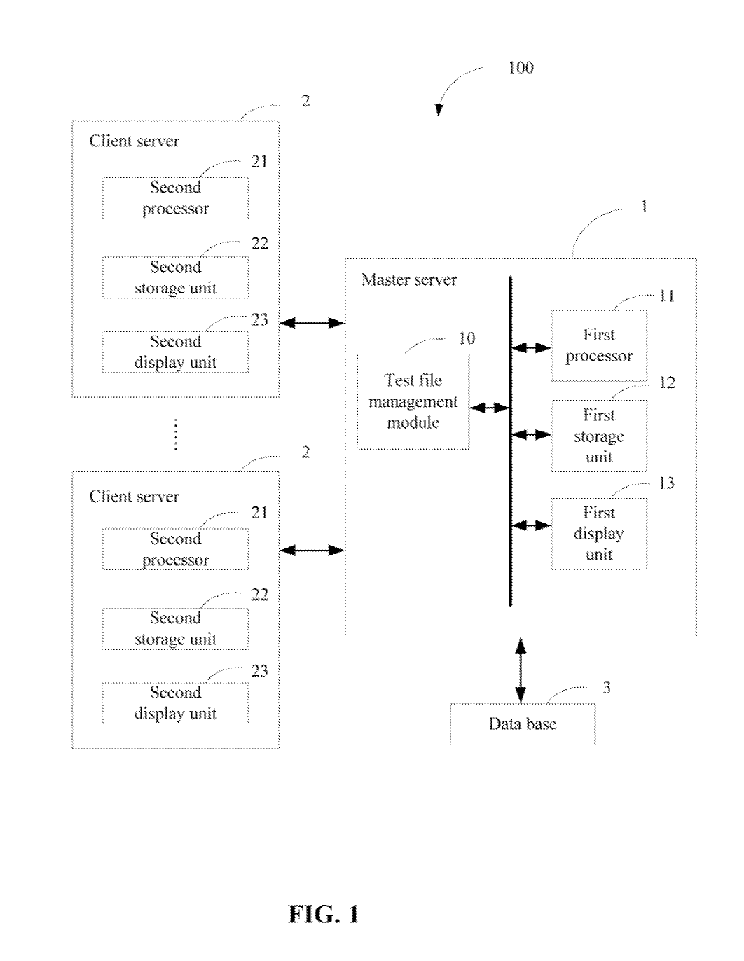

Referring to FIG. 1, a schematic block diagram illustrating one embodiment of a test system 100 according to the present disclosure is shown. The test system 100 includes a master server 1, at least one client server 2, and a database 3. In this embodiment, the master server 1 may communicate with the client server 2 and the database 3 via a network to perform a test process.

The master server 1 includes a test file management module 10, a first processor 11, a first storage unit 12 and a first display unit 13. In one embodiment, the test file management module 10 is executed by the first processor 11 for managing a test process of the test system 100 when the client server 2 accesses the master server 1 via the network. The test file management module 10 may include a plurality of programs in the form of one or more computerized instructions stored in the first storage unit 12 and executed by the first processor 11 to perform operations of the test system. The test file management module 10 may include a plurality of common format test files stored in the database 3. The test file management module 10 may control the first display unit 13 to display a first interface for a user such as an engineer to search and edit the test files in the database 3. In the embodiment, the master server 1 may be a computer and the database 3 may be any relational database. In the embodiment, the first interface may be a web based user interface.

The client server 2 includes a second processor 21, a second storage unit 22, and a second display unit 23. In one embodiment, the client server 2 may be a personal computer (PC), a portable computer, a tablet computer, a smart phone, or other smart electronic terminals. The client server 2 can be supported by at least two different operating systems (OS). The client server 2 receives a second interface from the master server 1 via the network and controls the second display unit 23 to display the second interface for a user such as an operator to perform different tests , record and send test result back to the master server 1 via the network. In the embodiment, the second interface may also be a web based user interface.

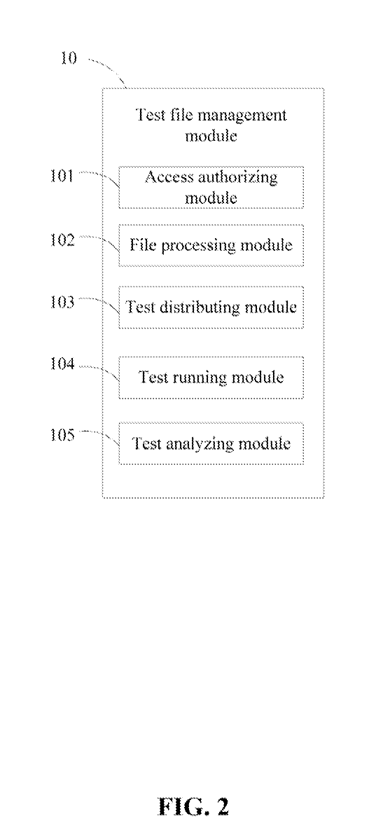

Referring to FIG. 2, a schematic block diagram illustrating one embodiment of test file management module 10 of FIG. 1 is shown. The test file management module 10 comprises an access authorizing module 101, a file processing module 102, a test distributing module 103, a test running module 104, and a test analyzing module 105. In one embodiment, users for the test file management module 10 may include an engineer and an operator.

The access authorizing module 101 is configured to set authorizations for different users to access to the test file management module 10 using the client server 2 or the master server 1. In this embodiment, the authorizations of a first user such as an engineer or a manager may include uploading test file, processing test file, and distributing test file using the first interface. The authorizations of a second user such as an operator may include receiving test file, running test file, recording test result, and sending back the test result to the master server 1.

The file processing module 102 is configured to receive test files uploaded by the engineer, transform the test files from a special format into a common format, and store information of the common test file into the database 3. In one embodiment, the engineer uploads a special format test file. The file processing module 102 transforms the test file from the special format into a common format such as an extensible markup language (XML) format. The common test file can be supported or run by two or more operating systems. The information of the common test file may include test types, test steps, and amount of test files. In one embodiment, the test type may include a first test type A, a second test type B, and a third test type C. In alternative embodiments, the file processing module 102 further translates the common test file from a first language into a second language or a target language.

The test distributing module 103 is configured to correspondingly distribute different test files to the client servers 2. In detail, the test distributing module 103 reads the information of the common test file from the database 3, generates a plurality of current test files to define a plurality of tests using the information of the common test file according to the amount of the client server 2, and distributes the current test files to different client server 2 according to the types and the amount of the tests .

In one embodiment, a common test file includes thirty test files of first test type A, thirty test files of second test type B, and thirty test files of third test type C to be performed. The three client servers 2 include a first client server, a second client server, and a third client server. In detail, the test distributing module 103 may define a first current test file and distribute the first client server to run thirty tests of first test type A according to the first current test file, define a second current test file and distribute the second client server to run thirty tests of second test type B according to the second current test file, and define a third current test file and distribute the third client server to run thirty tests of third test type C according to the third current test file. In alternative embodiments, the test distributing module 103 may distribute each client server 2 to run ten tests of first test type, ten tests of second test type B, and ten tests of third test type C.

The test running module 104 is configured to provide and display a second interface on the second display unit 23 according to different current test files, and control a process of each tests.

The test analyzing module 105 is configured to record and analyze test result. In detail, the test analyzing module 105 receives and records test result from the client server 2 and analyzes the test result by comparing the test result with some standard reference data, and determines whether the received test result is within a predetermined reasonable range. When the received test result is normal and within the predetermined reasonable range, the test analyzing module 105 stores the normal test result into the database 3 and links them with corresponding common test files. When the received test result is abnormal and exceeds the predetermined reasonable range, the test analyzing module 105 changes the color of the abnormal test result from a normal color such as black into an abnormal color such as red, displays the abnormal color test result on the first display unit 13 and emails the system administrator.

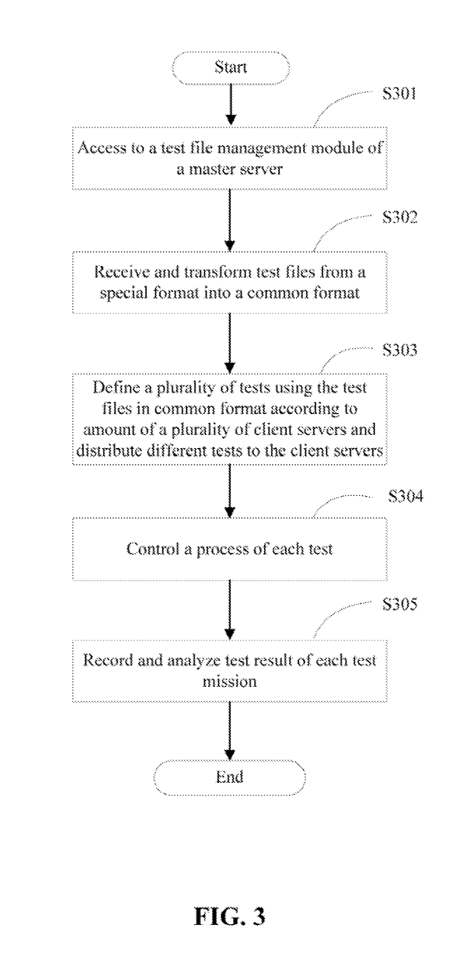

FIG. 3 is a flowchart of one embodiment showing a test method according to the present disclosures. The method is typically carried out using the test system 100 to automatically distribute current test files to different client servers 2. Depending on the embodiment, additional steps may be added, others removed, and the ordering of the steps may be changed.

In step S301, the access authorizing module 101 sets authorizations for different users to access to the test file management module 10. In step S302, the file processing module 102 receives and transforms test files from a special format into a common format. In step S303, the test distributing module 103 generates a plurality of current test files to define a plurality of tests using the information of the common test files according to the amount of the client servers 2, and correspondingly distributes the current test files to different client servers 2 according to the types and the amount of the tests. In step S304, the test running module 104 displays a second interface on a client server 2 to control a process of each test to obtain test result. In step S305, the test analyzing module 105 records and analyzes test result of each test. In alternative embodiment, a detail process of the method may refer to the functions of the test file management module 10 detailed above.

Even though numerous characteristics and advantages of certain inventive embodiments have been set out in the foregoing description, together with details of the structures and functions of the embodiments, the disclosure is illustrative only; and changes may be made in detail, especially in the matter of arrangement of parts within the principles of present invention to the full extent indicated by the broad general meaning of the terms in which the appended claims are expressed.

What is claimed is:

1. A test system comprising a master server configured to communicate with a plurality of client servers, the master server comprising a test file management module,
wherein the test file management module is configured for setting authorizations for different users, receiving and transforming a plurality of first test files from a special format into a common format, generating a plurality of second test files to define a plurality of tests using the common format first test files, distributing the second test files to a plurality of client servers, controlling a process of each test to obtain test result, and recording and analyzing test result of each test.

2. The test system of claim 1, wherein the test file management module further stores information of the common format test files into a database, the information of the common format test files comprises test types, test steps, and amount of test files.

3. The test system of claim 2, further comprising a first display to display a first interface for a user to search and edit the common format first test files in the database.

4. The test system of claim 3, wherein the test file management module further uses the first interface to set authorizations.

5. The test system of claim 4, wherein the test file management module provides a second interface to each client server.

6. The test system of claim 5, wherein each client server comprises a second display to display the second interface for a user to control the process of each test file.

7. The test system of claim 1, wherein the test file management module further translates the common format first test file from a first language into a second language.

8. The test system of claim 1, wherein the common format first test files are supported by at least two operation systems.

9. The test system of claim 1, wherein the test file management module stores the test result into a database and links the test result with corresponding test files, when the received test result is normal.

10. The test system of claim 9, wherein the test file management module emails the system administrator when the test result is abnormal.

11. A test method comprising:
setting authorizations for different users by using a test file management module of a master server;
receiving and transforming first test files from a special format into a common format by the test file management module;
generating a plurality of second test files to define a plurality of tests using the common format first test files,
distributing the second test files to a plurality of client servers by the test file management module;
controlling a process of each test to obtain test result by the test file management module; and
recording and analyzing test result of each test by the test file management module.

12. The test method of claim 11, further comprising storing information of the common format first test files into a database, the information of the common format first test files comprises test types, test steps, and amount of test files.

13. The test method of claim 12, further comprising displaying a first interface by a first display for a user to search and edit the common format first test files in the database.

14. The test method of claim 13, wherein the first interface is further used to set authorizations.

15. The test method of claim 14, further providing a second interface to each client server by the test file management module.

16. The test method of claim 15, wherein each client server comprises a second display to display the second interface for a user to control the process of each test.

17. The test method of claim 11, wherein the test file management module further translates the common format first test file from a first language into a second language.

18. The test method of claim 11, wherein the common format first test files are supported by at least two operation systems.

19. The test method of claim 11, wherein the test file management module stores the test result into a database and links the test result with corresponding test files, when the test result is normal.

20. The test method of claim 19, wherein the test file management module emails the system administrator when the test result is abnormal.
